(19) United States
(12) Patent Application Publication
(10) Pub. No.: US 2016/0307119 A1
(43) Pub. Date: Oct. 20, 2016

(54) MOBILE APP AND SYSTEM FOR EFFECTING TRANSPORTATION BASED ON LOCATION, VEHICLE TYPE AND FARE

(71) Applicant: MyRidez LLC, Long Island City, NY (US)

(72) Inventors: Issac Yehuda, Englewood Cliffs, NJ (US); Steve Humphrey, East Haven, CT (US); Kevin McArdle, Northport, NY (US); Kornel Cyrzyk, Bardonia, NY (US); Armand Ensanian, Newton, NY (US); Daniel V. Ensanian, Woodside, NY (US)

(21) Appl. No.: 14/686,019

(22) Filed: Apr. 14, 2015

(51) Int. Cl. G06Q 10/02; G06Q 50/32; G01S 19/13; G07B 15/02

(52) U.S. Cl. CPC G06Q 10/02; G07B 15/02; G06Q 50/32; G01S 19/13; G06Q 2240/00

(57) ABSTRACT

A user device allows arranging of transportation request or service and provides a user with an option to select a vehicle type and/or fare offer for the transportation. A geographical map displays the user device location determined via a GPS receiver. A user interface on the user device allows the user to enter or select a vehicle type and/or fare offer information. The geographical map is updated to show the positions of available vehicles within a defined area of a pickup location. The available vehicles may accept the fare offer or counter-offer. Based on the acceptance or counter-offer, the user may select a vehicle for transportation. The selected vehicle is notified of the selection. The geographical map is updated to show the position of the selected vehicle en route to the pickup location.

### FIELD

The present application relates generally to computers and computer applications, and more particularly to a computer application such as a mobile application and/or web application that allows a user to select transportation based on location, type of vehicle and/or fare information, for example, via a computer graphical user interface.

### BACKGROUND

Mobile device enabled car service management systems allow users to communicate their current location and request a car service. However, existing methodologies that arrange for transportation do not allow for users to pick the type of vehicle or a specific fare. The existing methodologies also do not allow a driver of a vehicle to accept user's offer of fare or counter-offer another fare.

### BRIEF SUMMARY

A method and system of providing transportation are provided. In one, a method for providing transportation may include presenting a user interface to allow a user to enter trip information comprising at least a pickup location and a destination location. The method may also include receiving the trip information entered on the user interface. The method may further include searching for available vehicles within a threshold distance of the pickup location, positions of the available vehicles determined via a global positioning system. The method may also include receiving from the user fare offer information entered on the user interface. The method may also include transmitting via a communication network, the trip information and the fare offer information to processing devices associated respectively with the available vehicles. The method may further include presenting on the user interface at least one of: vehicle information associated with the available vehicles that have accepted the fare offer information, to allow the user to select a vehicle; the vehicle information associated with the available vehicles that have presented counter-offers to the user's fare offer information, to allow the user to select a vehicle; a selection of available vehicles, driver profiles and ratings that have accepted the fare and are available to service the request; a selected vehicle. The method may also include notifying the selected vehicle of the user's selection via the communication network. The method may further include receiving from the selected vehicle a confirmation that the selected vehicle is en route to the pickup location. The method may also include presenting the confirmation on the user interface.

A system for providing transportation, in one aspect, may include a processor coupled to a user device. The processor may be operable to present a user interface on the user device to allow a user to enter trip information comprising at least pickup location, the user interface displaying a geographical map associated with a current location of the user, the current location determined by a global positioning system receiver device coupled to the user device. The processor may be further operable to receive the trip information entered on the user interface. The processor may be further operable to cause a server to search for available vehicles within a threshold distance of the pickup location, positions of the available vehicles determined via a global positioning system. The processor may be further operable to receive from the user fare offer information. The processor may be further operable to transmit via a communication network, the trip information and the fare offer information to processing devices associated respectively with the available vehicles. The processor may be further operable to present on the user interface at least one of: vehicle information associated with the available vehicles that have accepted the fare offer information, to allow the user to select a vehicle; the vehicle information associated with the available vehicles that have presented counter-offers to the user's fare offer information, to allow the user to select a vehicle; a selection of available vehicles, driver profiles and ratings that have accepted the fare and are available to service the request; a selected vehicle. The processor may be further operable to notify the selected vehicle of the user's selection via the communication network. The processor may be further operable to receive from the selected vehicle a confirmation that the selected vehicle is en route to the pickup location. The processor may be further operable to present the confirmation on the user interface.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIGS. 1A-1, 1A-2, 1B-1 and 1B-2 illustrate a flow diagram illustrating a method for an application, for example, residing and executing on a mobile device, that allows a user to select transportation based on one or more of type of vehicle and/or desired fare in one embodiment of the present disclosure.

FIG. 2 is a diagram illustrating system components that implement an application such as a mobile app that allows a user to select transportation in one embodiment of the present disclosure.

FIG. 3 is a high-level flow diagram illustrating a method of the present disclosure that allows a user to select a vehicle type in one embodiment.

FIG. 4 is a high-level flow diagram illustrating a method of the present disclosure that allows a user to select a fare for transportation service in one embodiment.

FIG. 5 illustrates a schematic of an example computer or processing system that may implement a system that allows a user to select transportation based on one or more of type of vehicle and/or desired fare in one embodiment of the present disclosure.

FIGS. 6A-6M illustrate example screen shots of an app user interface in one embodiment of the present disclosure.

### DETAILED DESCRIPTION

Techniques for allowing a user to select or arrange transportation based on location (e.g., user's location), type of vehicle and/or fare information are disclosed. The techniques integrate a plurality of mobile devices, a backend server and location identifying devices such as global positioning system (GPS) receivers, and enable a user to choose a desired type of vehicle for transportation, and to choose a desired fare, for example, bid for a fare for the transportation. For instance, via a mobile application GUI, a user may bid or offer a fare in real-time, and a driver may counter-offer and/or accept the user's bid in real-time. In one aspect, the techniques allow for real-time interactive and dynamic fare bidding in selecting a vehicle for transportation. The techniques of the present disclosure in one embodiment may be implemented as a computer application, e.g., an app enabled to execute on a user device such as a mobile phone, smartphone, phablet, laptop, and/or another device, that interfaces with the user.

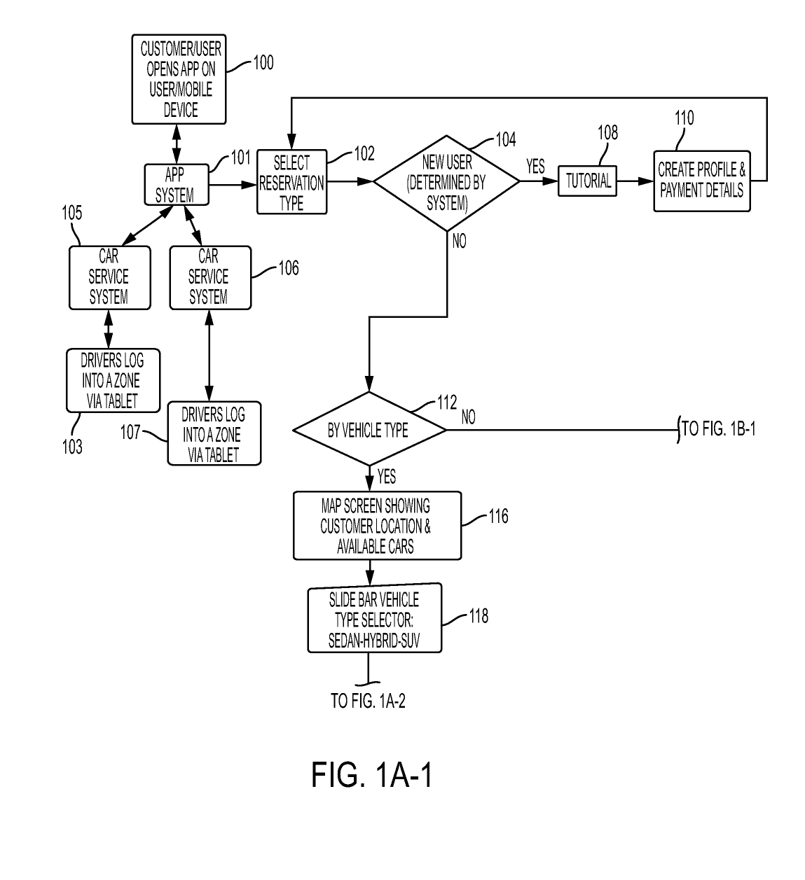

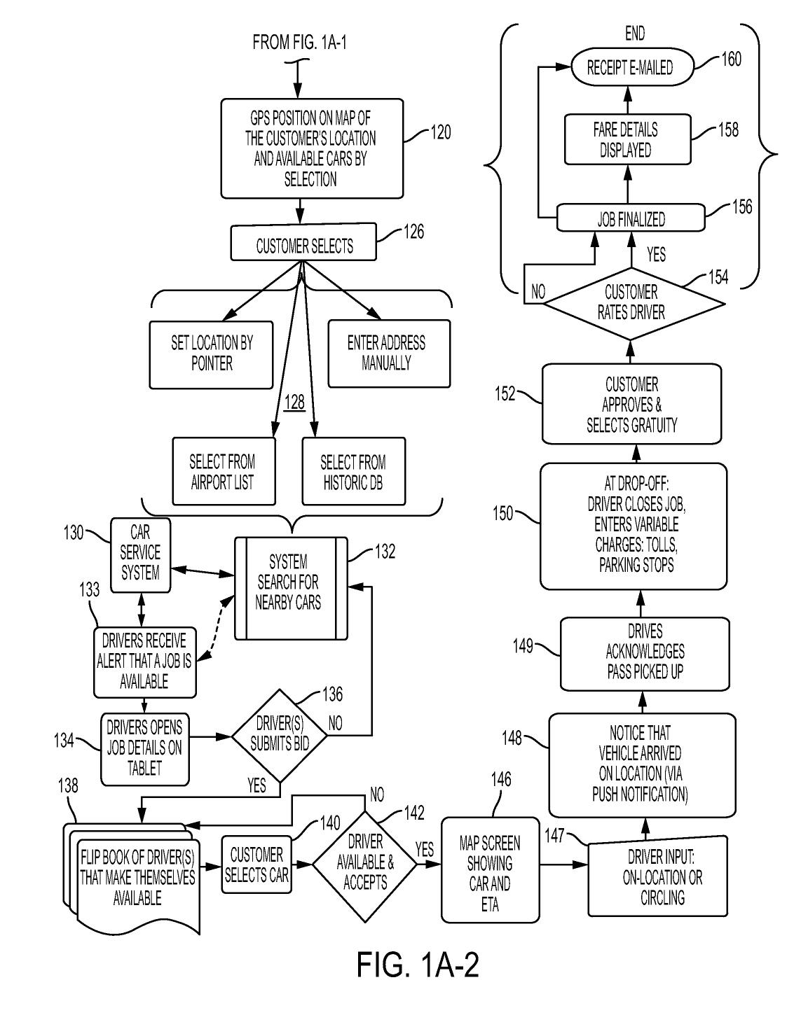

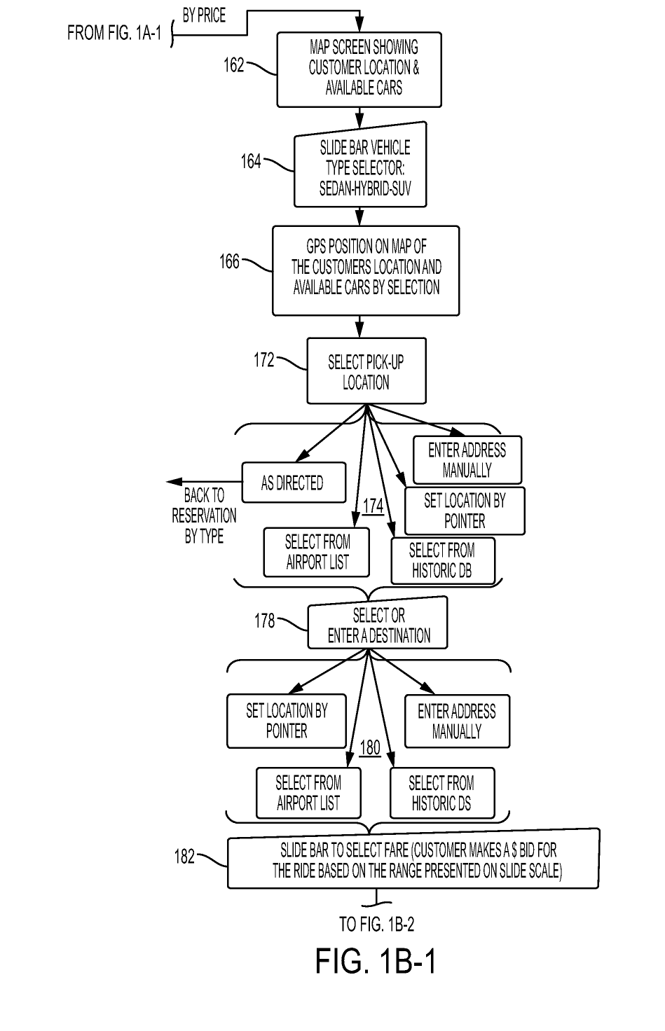

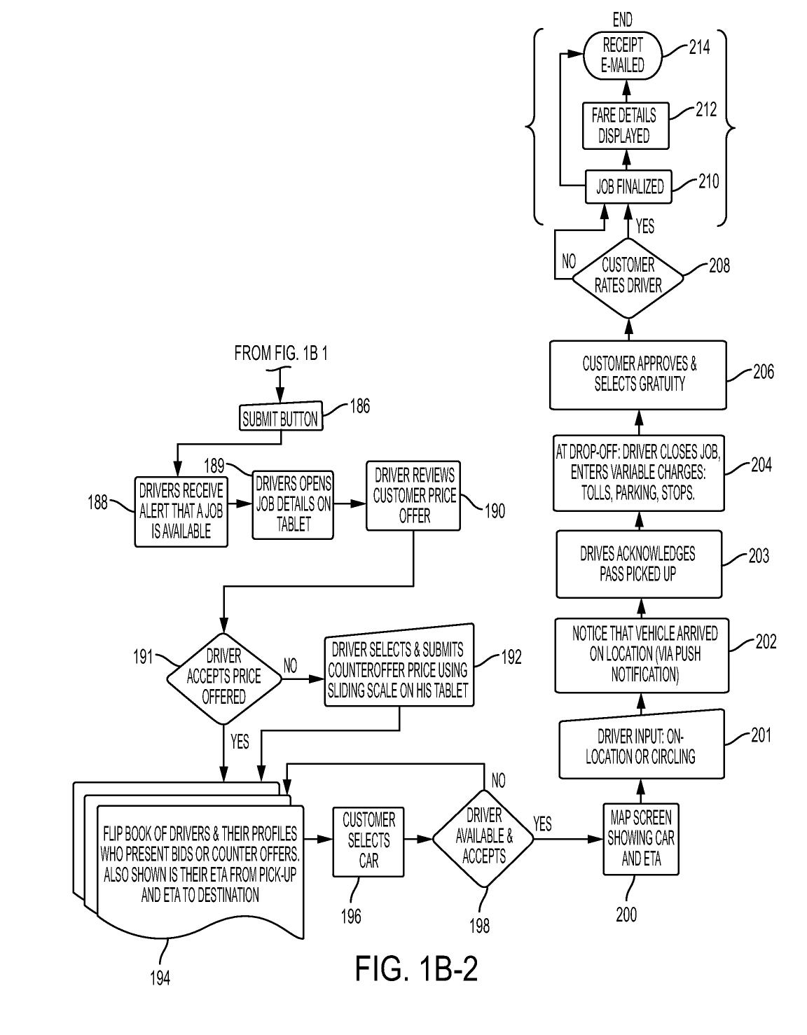

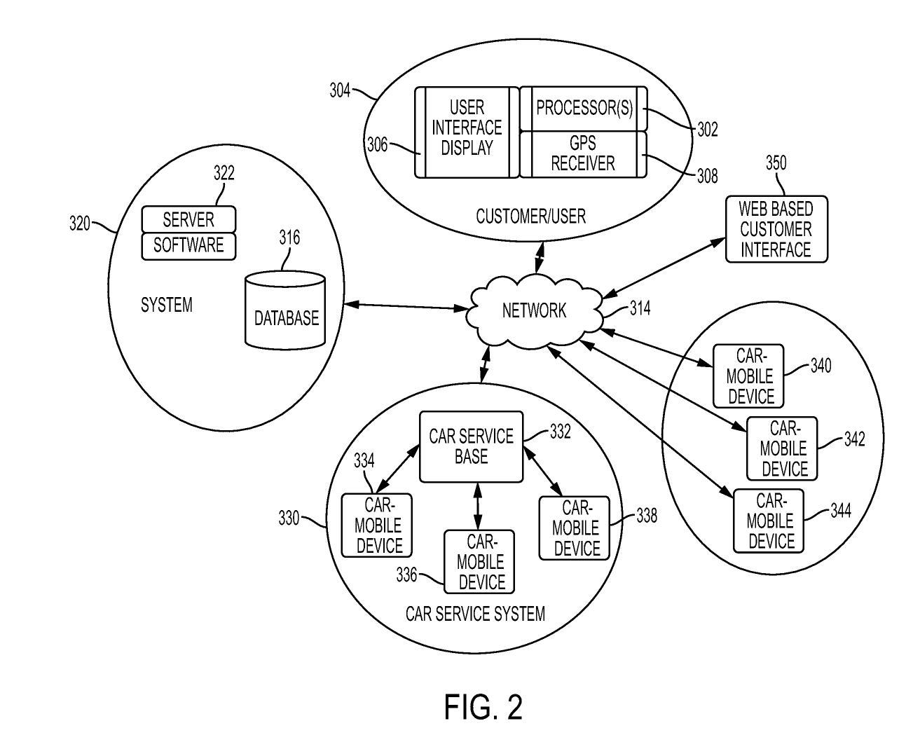

FIGS. 1A-1, 1A-2, 1B-1 and 1B-2 illustrate a flow diagram illustrating a method for an app (e.g., a mobile app that is downloaded to a user device) that allows a user to select a transportation service based on one or more of type of vehicle and/or desired fare in one embodiment of the present disclosure. An app or a mobile app implementing a methodology of the present disclosure in one embodiment may be launched on a user device (e.g., mobile device) and executed on it. Such an app may communicate with a backend server system and a GPS device including a GPS receiver in providing its functionalities to the user.

At 100, a user opens an app on the user device, for example, a mobile phone, smart phone, phablet, tablet, laptop, or another mobile device, and the app executes on the device. At 101, the app may communicate with a backend system (referred to as an app system), for example, that is located remotely, via a wireless communication. The backend system in turn may communicate with other servers or the like that are in communication with vehicle driver's devices. For example, at 103 and 107, drivers of vehicles via their devices such as tablets and other mobile devices may log onto respective servers of their car companies (e.g., 105, 106), specifying their zone or location. At 105 and 106, the servers of car companies are in communication with the backend system. In another aspect, the vehicle drivers 103, 107 may communicate directly with the backend system referred to at 101.

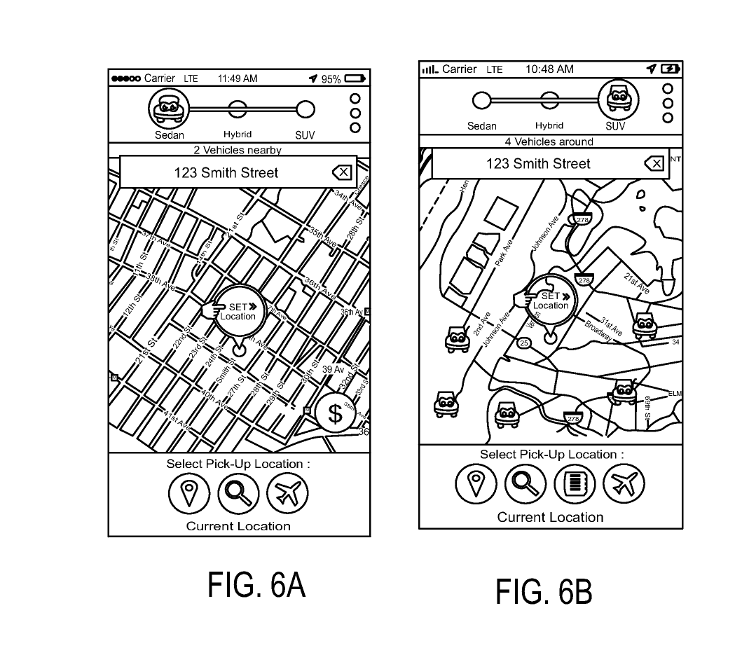

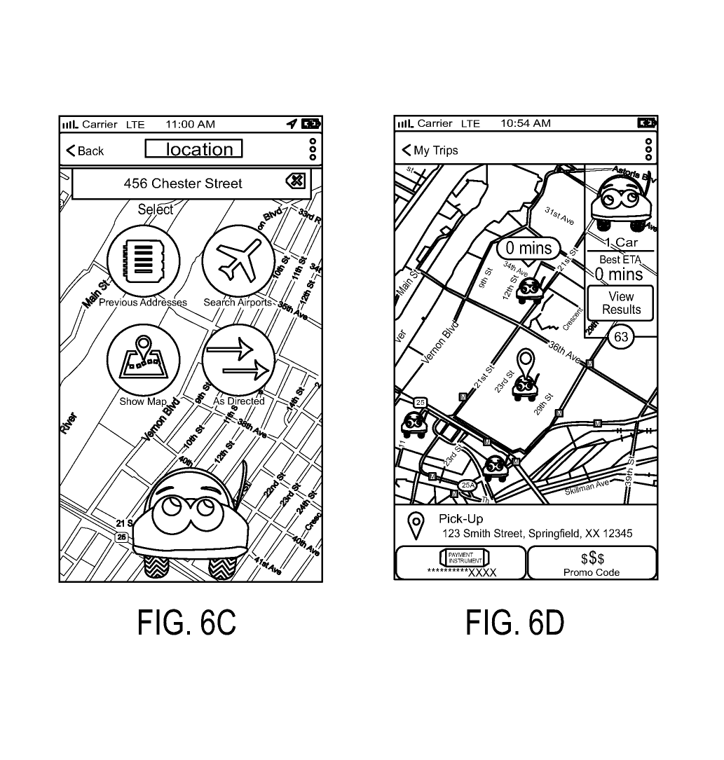

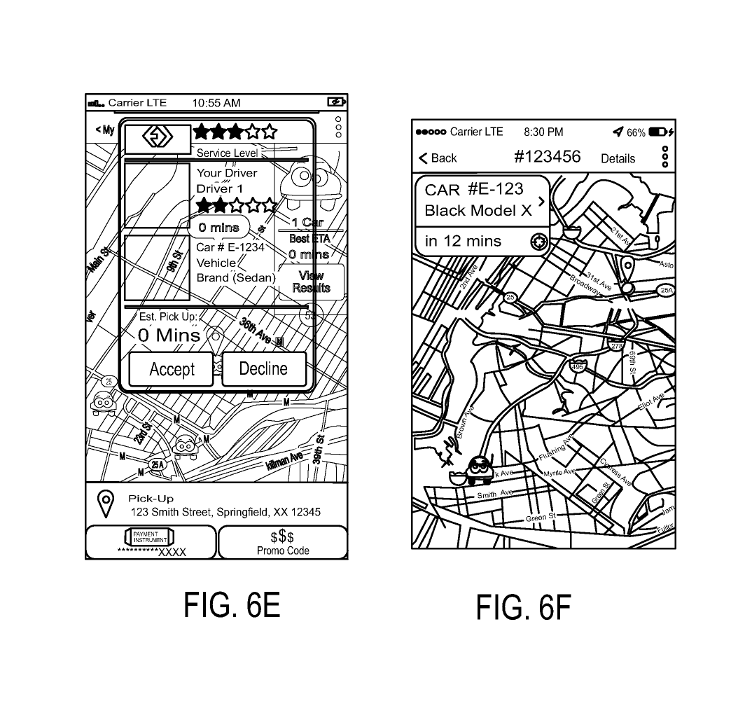

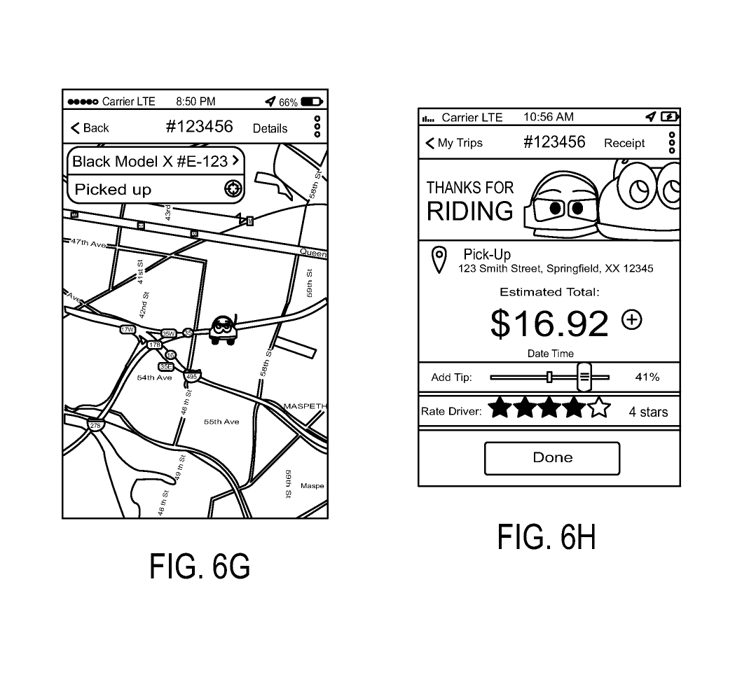

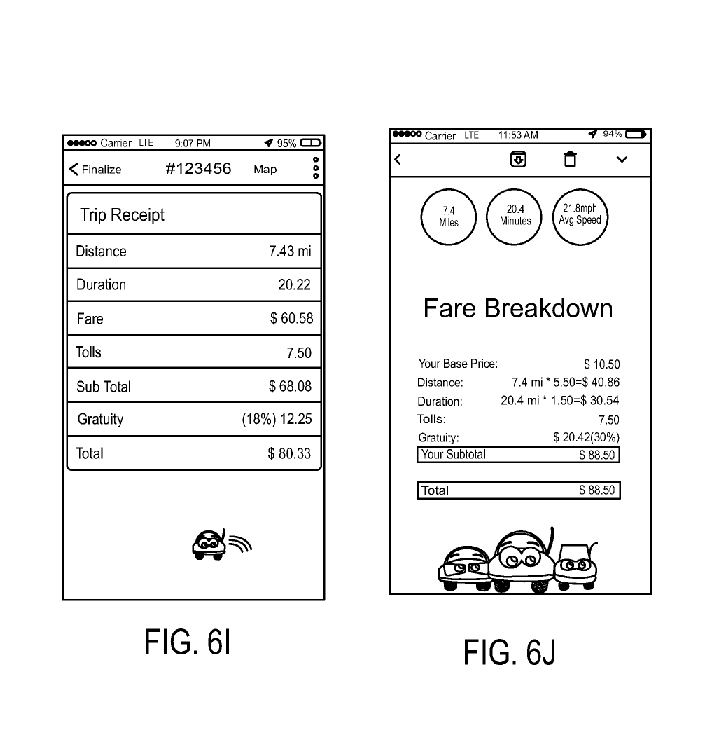

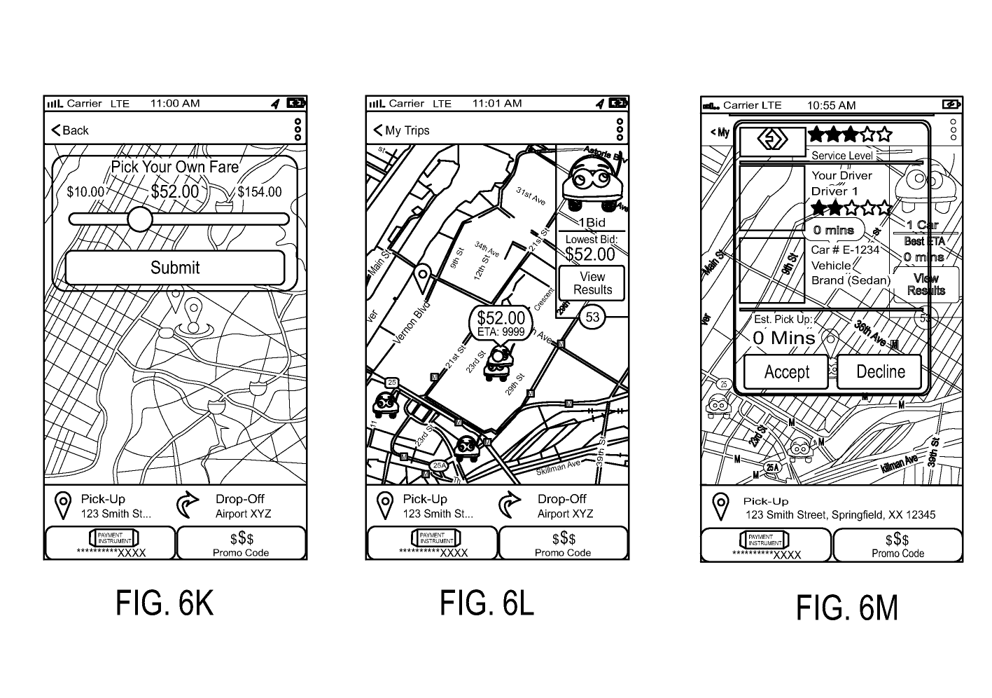

At 102, a user interface may be presented on the user device, for example, a mobile phone, smart phone, phablet, or another mobile device. The user interface allows a user to select a reservation type. In one embodiment, a methodology of the present disclosure provides different options for making a reservation, e.g., different types of reservation. For instance, a user may reserve a vehicle for transportation by vehicle type, and/or the user may reserve a vehicle for transportation by the amount of transportation fare the user would like to spend. FIG. 6A shows an example screen shot of the user interface that allows a user to reserve by a vehicle type, e.g., sedan, hybrid, sport utility vehicle.

At 104, a check is made to determine whether a user is a new user or an existing user. For instance, the user may have a login name or the like which the user provides on the user interface. The backend system in one embodiment checks a database of users to determine whether the login name exists in the database. The database stores information associated with existing users. If the database does not contain the user's login name (or another identifier associated with the user), the user is determined to be a new user. For a new user, at 108, a tutorial may be provided or presented via the user interface (e.g., on another page or screen of the user interface) on the user's device, and at 110, profile and payment details may be created for the new user. For instance, the user may enter information for creating the profile and preferred payment method details on the user interface. The app running on the mobile device may transmit the information to the backend system, which creates a database record of the user's profile and payment method details. In one embodiment, the created profile and payment details are stored in the database. The processing continues to 102, where reservation type is received. For instance, the app's user interface on the user's mobile device presents input fields via which the user may enter the reservation type.

In one embodiment, based on the option or reservation type selected or entered by the user, the processing may continue at 114 or 162. For instance, if the reservation type is reservation by vehicle type, then the processing logic continues at 114. If the reservation type is reservation by naming a fare (price), the processing logic continues at 162. In one embodiment, both options may be taken, in which case a user is allowed to select a vehicle type and name a fare.

Referring to 112, if the reservation type is by vehicle type, a geographic map screen showing the user's location and available vehicles are presented on the user interface at 116. FIG. 6B shows an example screen shot of the user interface showing, e.g., user location and available vehicles. The user's location may be determined via a global positioning system (GPS) receiver device, for example, coupled to the user's device. At 118, the user interface also presents an input graphical element for allowing a user to input a vehicle type. For instance, a slide bar vehicle selector comprising different types of vehicles (e.g., sedan, hybrid, sport utility vehicle) may be presented, from which a user can select a vehicle type.

At 120, the geographic map screen is updated with the GPS positions of the location of the user and the available vehicles of the selected vehicle type. For instance, the geographic map screen shows the positions of the user and the available vehicles of the selected vehicle type on the map. In one embodiment, the GPS positions of the available vehicles may be obtained from the backend system, which for example, communicates a server that includes the current location or zone information associated with one or more vehicle devices (e.g., 103, 107). In another aspect, the backend system may directly communicate and/or receive location information of the vehicles from a fleet of vehicles (via associated vehicle devices) in a specific zone.

At 126, the user is enabled to select or enter via the user interface a pickup location. For example, as shown at 128, the user may select his or her current location indicated on the geographic map screen, the user may enter an address, the user may select from a list of choices provided on the user interface, e.g., a list of airports, a list of historic locations. For instance, the user interface may receive a list of airports and/or list of historic locations where the user has been to previously from a system and transaction database 130. FIG. 6C shows an example of a screen shot of the user interface via which the user may select destination.

At 132, vehicles that are currently in the vicinity of the pickup location indicated at 128 are searched for. Those vehicles that are within a threshold distance from the pickup location may be determined. For example, the backend system may communicate with a server 130 that is in communication with the vehicles, and for example, has knowledge of vehicle locations. In one embodiment, via the server 130, the backend system may communicate to the vehicles that a job is currently available. So, for example, at 133, a driver of a vehicle receives information that the job is available, and at 134 may view the job details via the driver's device such as a tablet. In another embodiment, the backend system may communicate directly with the one or more vehicles regarding the job is currently available, without communicating to a server shown at 130. FIG. 6D shows an example screen shot of the user interface that presents available vehicles.

At 136, based on the job detail, a driver of a vehicle may submit a bid to take the job, indicating that the driver is available to take the job. At 138, a list or set of vehicles are determined based on one or more driver's indication for availability. A driver may indicate availability, for example, directly to the backend system or via a server 130. If no vehicles are available at 136, the backend system may repeat the search at 132. FIG. 6E shows an example screen shot of the user interface that may present the availability of one or more vehicles and driver information.

The mobile app may receive vehicle positions via a backend system of those vehicles that are available for the job. A graphical symbol representing a vehicle may be overlaid on the geographic map screen, for example, for each of the vehicles that are within the threshold distance. The threshold distance value may be predefined or configurable, and may be based on the actual distance and/or current travel time between the location of the vehicles and the pickup location.

At 136, if no available vehicles are found within the threshold distance of the pickup location, the searching continues at 132. If at 136, there are available vehicles, at 140, a vehicle is selected from a list of available vehicles 138, and the driver of the vehicle is notified of the selection. For instance, a list of available vehicles may be presented to the user on the user interface, allowing the user to input a selection. At 142, if the driver of the vehicle (e.g., selected by the user) accepts to provide transportation, the processing logic proceeds to 144. If at 142, the driver of the selected vehicle does not accept to provide the transportation, another driver from the list of available vehicles 138 is selected and notified. For instance, the user may be allowed to select another vehicle from the list of available vehicles. In another aspect, an alternative vehicle may be automatically selected for the user by the app or the backend system, which for example, the user may override. The selecting continues until a driver accepts the transportation.

The selected vehicle driver's acceptance is received. At 146, the user interface's geographic map screen is updated with the position of the selected vehicle and an estimated time of arrival of the selected vehicle at the user location. FIG. 6F is an example screen shot of a user interface that presents this information. In one aspect, the position of the selected vehicle may be determined by a GPS server that communicates with the selected vehicle for the vehicle's position as the vehicle moves toward the user location.

At 147, the vehicle may indicate that it is at the pickup location or for example is circling in the vicinity of the location. The input for example is entered by the vehicle's driver, e.g., on a tablet associated with the vehicle, and may be received by the backend system. At 148, a notification is received, for example, by the backend system, that the vehicle arrived on the pickup location. At 149, the vehicle (e.g., the vehicle's driver via the vehicle device) acknowledges that a passenger (e.g., the user) has been picked up. FIG. 6G is an example screen shot of the user interface that may be presented responsive to the pickup.

At 150, the selected vehicle's driver closes this job (transportation service), enters various applicable charges such as tolls, parking, and/or others.

At 152, the user approves and selects gratuity. At 154, the user is enabled via the user interface to rate the selected vehicle's transportation service, e.g., rate the transportation experience. FIG. 6H shows an example screen shot of the user interface that may be presented for allowing a user to select gratuity and rate the transportation experience. At 156, the job is finalized. At 158, fare details are displayed on the user interface and may be emailed or sent to the user, e.g., with a receipt at 160. FIG. 6I shows an example screen shot of the user interface that may be presented at 158. FIG. 6J shows an example screen shot of the user interface that may present a receipt. In one aspect, the information about this transportation service may be stored in a database. For example, the user, the pickup location, destination information may be stored, e.g., for use in providing subsequent transportation service to the user.

Referring back to 112, if the reservation type is reservation by naming a user's own fare, a geographic map screen showing the user's location and available vehicles are presented on the user interface at 162. The user's location may be determined via a global positioning system (GPS) receiver device, for example, coupled to the user's device. At 164, the user interface may also present an input graphical element for allowing a user to input a vehicle type. For instance, a slide bar vehicle selector comprising different types of vehicles (e.g., sedan, hybrid, sport utility vehicle, all types) may be presented, from which a user can select a vehicle type.

At 166, the geographic map screen is updated with the GPS positions of the location of the user and the available vehicles of the selected vehicle type. For instance, the geographic map screen shows the positions of the user and the available vehicles of the selected vehicle type on the map. The GPS positions of the available vehicles may be obtained from a GPS server that communicates with a fleet of vehicles in a specific zone. In another aspect, the GPS server may communicate with another server that communicates with a fleet of vehicles in a specific zone.

At 172, the user is enabled to select or enter via the user interface a pickup location. For example, as shown at 174, the user may select his or her current location indicated on the geographic map screen, the user may enter an address, the user may select from a list of choices provided on the user interface, e.g., a list of airports, a list of historic locations. For instance, the user interface may receive a list of airports and/or list of historic locations where the user has been to previously from the backend server that searches for user associated information in a database. In another aspect, the user interface may also allow the user to navigate back to reservation type selection, for example, to 112.

At 178, the user is enabled to enter a destination location on the user interface. For example, a screen shot such as the one shown in FIG. 6C may be presented for allowing the user to enter the destination location. As shown at 180, the user may select his or her current location indicated on the geographic map screen, the user may enter an address, the user may select from a list of choices provided on the user interface, e.g., a list of airports, a list of historic locations.

At 182, an input element is presented on the user interface for allowing the user to enter a fare. FIG. 6K shows an example screen shot of the user interface that allows the user to enter or bid for a fare. For example, a slide bar element may be displayed for enabling the user to select a fare. The user may make a bid for the ride (transportation service) based on the range of fares presented on the user interface. The range of fares may be displayed based on the information stored in a zone/rate table database that stores fare information based on locations or zones.

At 186, a user is enabled to submit the selected fare for bidding, e.g., by pressing or selecting a button or another input element on the user interface, for example, the ‘submit’ button shown in FIG. 6K. The information about this transportation (e.g., the pickup location, destination location, selected fare) is transmitted to the backend system. The backend system searches for vehicles within a defined geographic distance. For instance, the backend system may communicate with a server that in turn has information about vehicles registered or logged into a specific zone or location.

At 188, those vehicles are notified of the available job. For instance, the backend system may directly communicate with the vehicles, or another server may communicate that information to the vehicles. At 189, the drivers of the vehicles may view the job details (for example, the pickup location, destination location, selected fare), for example, via the vehicle associated device such as a tablet. At 190, the drivers of the vehicles review price/fare offer. At 191, one or more drivers may accept the offer. In another aspect, the driver may counter-offer the fare price at 192, for example, via the vehicle's device, which may also present a user interface that allows the vehicle driver to input selections. The counter-offer fare then may be communicated to the user, who may accept or decline the counter-offer.

At 194, a list of all of the vehicles that accepted the fare offer is presented on the user interface. FIG. 6L shows an example screen shot of the user interface that presents the vehicles that accepted the fare offer. This list may include those vehicles that counter-offered and whose counter-offer the user accepted. The user interface may also present each vehicle's estimated time of arrival to the pickup location and/or from the pickup location to the destination location.

At 196, the user interface presents the list of vehicles for the user to select from. FIG. 6M shows an example screen shot of the user interface that presents the list of vehicles for the user to select from. A vehicle in the list may be displayed per panel, for example, as shown in FIG. 6M, and the user may select to ‘accept’ or ‘decline’ that particular vehicle. The user may also navigate through a plurality of panels, for example, by selecting to view the next panel, for example, by pressing a back arrow or forward arrow displayed on a portion of the panel. At 198, it is confirmed that the driver of the vehicle accepted the offer (user's acceptance). If not, another vehicle may be selected, for example, by iterating 194 and 196.

At 200, the user interface's geographic map screen is updated with the position of the selected vehicle and an estimated time of arrival of the selected vehicle at the user location. In one aspect, the position of the selected vehicle may be determined by a GPS server that communicates with the selected vehicle for the vehicle's position as the vehicle moves toward the user location.

At 201, the vehicle may indicate that it is at the pickup location or for example is circling in the vicinity of the location. The input for example is entered by the vehicle's driver, e.g., on a tablet associated with the vehicle, and may be received by the backend system. At 202, a notification is received, for example, by the backend system, that the vehicle arrived on the pickup location. At 203, the vehicle (e.g., the vehicle's driver via the vehicle device) acknowledges that a passenger (e.g., the user) has been picked up.

At 204, the selected vehicle's driver closes this job (transportation service), enters various applicable charges such as tolls, parking, and/or others.

At 206, the user approves and selects gratuity. At 208, the user is enabled via the user interface to rate the selected vehicle's transportation service, e.g., rate the transportation experience. At 210, the job is finalized. At 212, fare details are displayed on the user interface and may be emailed or sent to the user, e.g., with a receipt at 214. In one aspect, the information about this transportation service may be stored in a database. For example, the user, the pickup location, destination information may be stored, e.g., for use in providing subsequent transportation service to the user.

A driver side of the application described above also may include a user interface with appropriate screens presented to the driver for allowing the driver to interact, e.g., with the backend system.

FIG. 2 is a diagram illustrating system components that implement a mobile app that allows a user to select transportation in one embodiment of the present disclosure. The components shown in FIG. 2 may implement the methodology described above with reference to FIGS. 1A-1, 1A-2, 1B-1 and 1B-2. One or more processors 302 (e.g., microprocessors) may be incorporated in, or coupled to, a device 304, e.g., a mobile device such as mobile phone, laptop, tablet, phablet, or another device. The device 304 may also include a network card such as a wireless communication card. The one or more processors function to provide the above described methodologies of an app. For example, a processor 302 may execute the app and present a user interface on the user device, e.g., the user device's display/input screen 306, to allow a user to enter trip information comprising at least pickup location. The user interface may display a geographical map associated with the current location of the user (e.g., the user carrying the user device). For instance, the user device 304 may include a location aware device such as a global positioning system (GPS) receiver 308 that communicates with GPS, for example, which receives GPS satellite signals, to determine the current location.

The user interface display or screen 306 may include an input field that allows a user to enter trip information that may include one or more of a pickup location and destination location. The processor 302 receives the trip information entered on the user interface. In one embodiment, the processor 302 via the user interface may allow a user to enter or select a vehicle type. The processor 302 may also allow a user to enter fare offer information, e.g., by presenting an input field or element. For instance, for entering or selecting a vehicle type, a slide bar input element showing a list of available vehicle types may be presented on the user interface. Similarly, for entering or selecting fare offer, a slide bar input element showing a list of fares (or a range of fares) may be presented on the user interface. The range of fares displayed on the user interface may be retrieved from a fare database storing fares according to location zones. Any other types of input fields/elements may be presented for allowing a user to select or enter input information.

Responsive to receiving the fare offer information, the processor 302 may transmit, e.g., via a communication network 314, the trip information and the fare offer information to eventually reach the processing devices associated respectively with the available vehicles. For instance, the information may be transmitted to a backend system that communicates the information to a server or the like that communicates to the processing devices associated with the available vehicles. Communication network 314 may include any one or combination of communication such as wireless, wired, satellite, cellular, radio frequency, and others. If, for example, the user also selected a vehicle type, the available vehicles include vehicles of the selected vehicle type and the fare offer information is sent to the available vehicles of the selected vehicle type. The user interface may display the positions of the available vehicles on the geographical map.

The processor 302 may receive information from the available vehicles regarding the fare offer. For example, an available vehicle may have accepted the fare offer information. Another available vehicle may have counter-offered a different fare. The processor 302 may present the information on the user interface, so that a user may decide which vehicle to select based on the information. The processor 302 may also present a selection of available vehicles, driver profiles of those vehicles and rating information associated with the vehicles that have accepted the fare and available to service the user's transportation request. The user may select a vehicle from the available vehicles, for example, based on the information. Yet in another aspect, the processor 302 may select an available vehicle automatically for the user based on the available vehicle's acceptance of the user's fare offer. In that case, the user interface presents the selected vehicle and associated information such as driver profiles and rating information.

Once a vehicle is selected, the processor 302 may notify the selected vehicle of the user's selection, e.g., via the communication network 314. The processor 302 may receive from the selected vehicle a confirmation that the selected vehicle is en route to the pickup location. The processor 302 may present the confirmation on the user interface. The processor 302 may present on the user interface payment processing information and payment receipt, e.g., once the trip is complete.

A backend system 320 may comprise one or more servers with hardware processors and backend software that interact with the user device 330. For example, the server 322 of the backend system 320 may receive the trip information entered on the user interface of the user device 304. The server 322 may search for available vehicles within a threshold distance of the pickup location. For instance, the server 322 may communicate with one or more vehicles (devices associated with the vehicles) or with another server or service that communicates with one or more vehicles (devices associated with the vehicles) to determine the positions of the vehicles. The server 322 may send a request for the positions of available vehicles in the nearby areas (e.g., within a defined threshold distance) of the pickup location, and receive the information about the available vehicles in the nearby areas. The backend system 320 may also include a database 316 that store information associated with users, e.g., user profile that may specify user login identifier, preferred payment method, other user preferences, history of locations the user has traveled to, and/or other information. The database 316 may also include fare information for different locations or zones.

A car service system 330 may include one or more processors that execute a reservation/dispatch software or like tool referred to as a car service base 332 in one embodiment of the present disclosure. In one embodiment, communications between a user device 304 and vehicles (e.g., a device associated with a vehicle for communicating) 334, 336, 338 may be performed via the car service system 330. For instance, the vehicles 334, 336, 338 may login to the car service system 330, and send their location information (determined via GPS receivers on the respective vehicles). The car service system 330 may keep track of the locations of the vehicles and also communicate trip information and user offers of fare information received from the backend system 320 to the vehicles 334, 336, 338. The vehicles devices may also run an application that provides a user interface for allowing the vehicles drivers (or the like) to view and input information. The car service system 330 may also receive accepted offers and/or counter-offers from the vehicles 334, 336, 338 and communicate that information to the backend system 320. The backend system 320 sends that information to the user device 304.

In one embodiment, one or more vehicles 340, 342, 344 may include capability (e.g., an application with a user interface) to directly communicate with the backend system 320 and the user device 304 without having to register or login to the car service system 330, in interacting with the user device for providing the transportation methodology described above.

A web-based user interface 350 may provide the similar functionalities of the user device 304. For example, the web-based user interface 350 presents a user interface for allowing a user to enter trip information and select a vehicle type and/or offer fare information. The web-based user interface 305 communicates with the backend system 320 for performing the functions described above.

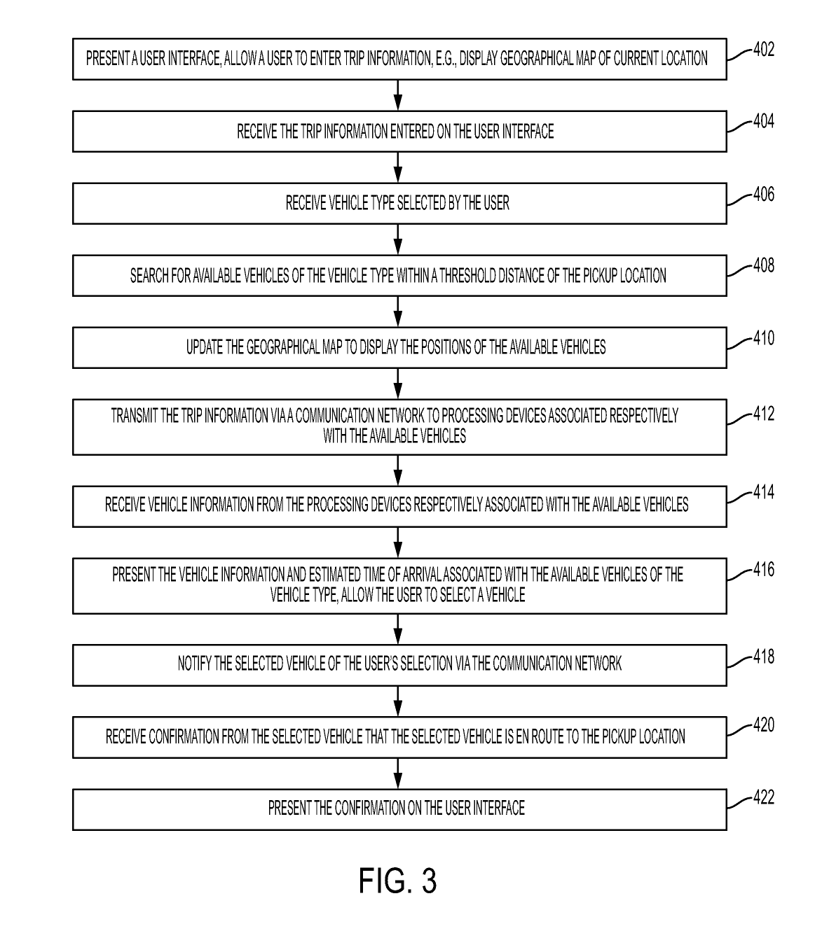

FIG. 3 is a high-level flow diagram illustrating a method of the present disclosure that allows a user to select a vehicle type in one embodiment. At 402, a user interface is presented on a user device to allow a user to enter trip information. The trip information includes at least a pickup location. The user interface may display a geographical map associated with a current location of the user (e.g., the user device). The current location may be determined by a global positioning system receiver device coupled to the user device. Selecting an area on the geographical map may automatically populate the pickup location or a destination location or both.

At 404, the trip information entered on the user interface is received. At 406, a vehicle type selected by the user is received. At 408, a search is performed for available vehicles of the vehicle type within a threshold distance of the pickup location. For instance, the positions of the available vehicles may be determined from a server that tracks vehicles that logged into the server and indicated their locations or zones. The vehicles (or processing devices carried on the vehicles) may have respective global positioning system receivers that determine the vehicles locations. The vehicles (or processing devices carried on the vehicles) communicate the location information to the server.

At 410, the geographical map may be updated to display the positions of the available vehicles. At 412, the trip information may be transmitted via a communication network to processing devices associated respectively with the available vehicles. At 414, vehicle information is received from the processing devices respectively associated with the available vehicles.

At 416, the user interface presents the vehicle information and estimated time of arrival associated with the available vehicles of the vehicle type to allow the user to select a vehicle. The vehicle information may include at least driver information, service level, and fare information. At 418, the selected vehicle is notified of the user's selection via the communication network. At 420, confirmation is received from the selected vehicle that the selected vehicle is en route to the pickup location. At 422, the confirmation is presented on the user interface.

The user interface may also present payment processing information and payment receipt. Payment processing may be performed according to information stored in a user's profile. In case a user's profile does not exist, the user may be prompted to create the profile or enter the payment method. In one aspect, the trip information associated with the current transaction may be stored in a transaction database. Such information may be retrieved and used for pre-populating user interface fields in future transactions.

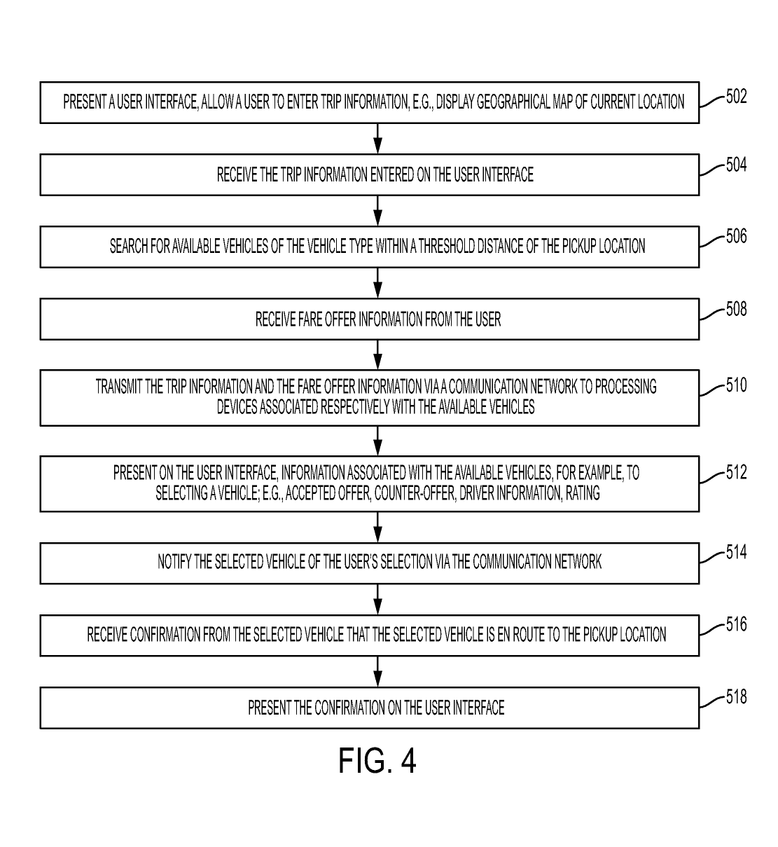

FIG. 4 is a high-level flow diagram illustrating a method of the present disclosure that allows a user to select a fare for transportation service in one embodiment. At 502, a user interface is presented to allow a user to enter trip information. The trip information may include at least a pickup location and a destination location. At 504, the trip information entered on the user interface is received. At 506, searching is performed for available vehicles within a threshold distance of the pickup location. For instance, the positions of the available vehicles may be determined from a server that tracks vehicles that logged into the server and indicated their locations or zones. The vehicles (or processing devices carried on the vehicles) may have respective global positioning system receivers that determine the vehicles' locations. The vehicles (or processing devices carried on the vehicles) communicate the location information to the server.

At 508, fare offer information is received from a user.

At 510, the trip information and the fare offer information is transmitted via a communication network to processing devices associated respectively with the available vehicles. A processing device associated with an available vehicle may include, but is not limited to, a device coupled to the available vehicle that can receive/transmit information over a communication network, a mobile device that a driver of the available vehicle may carry (e.g., mobile phone, tablet), or another such device.

At 512, one or more of the following information may be presented on the user interface, for example, to selecting a vehicle: vehicle information associated with the available vehicles that have accepted the fare offer information; the vehicle information associated with the available vehicles that have presented counter-offers to the user's fare offer information; a selection of available vehicles, driver profiles and ratings that have accepted the fare and are available to service the request; a selected vehicle. A user may select a vehicle, for example, based on the information.

At 514, the selected vehicle is notified of the user's selection, e.g., via the communication network. At 516, confirmation is received from the selected vehicle that the selected vehicle is en route to the pickup location. At 518, the confirmation is presented on the user interface. At 518, the user interface payment processing information and payment receipt may be presented on the user interface.

The user interface may display a geographical map associated with a current location of the user, the current location determined by a global positioning system receiver device coupled to the user device. The user interface may also display the positions of the available vehicles, for example, the map may be updated to display the positions of the available vehicles that are identified as a result of searching. The map further may be updated to the selected vehicle en route to the pickup location.

As described above, the user may be also given an option to select a vehicle type. If the user selects a vehicle type, vehicles of the selected type are searched for available vehicles.

In one aspect, the functionalities and modules of the system and methods of the present disclosure may be implemented or carried out distributedly on different processing systems or on any single platform, for instance, accessing data stored locally or distributedly on the network.

Various aspects of the present disclosure may be embodied as a program, software, or computer instructions embodied or stored in a computer or machine usable, readable or executable medium, which causes the computer or machine to perform the steps of the method when executed on the computer, processor, and/or machine. For instance, a program storage device readable by a machine, tangibly embodying a program of instructions executable by the machine to perform various functionalities and methods described in the present disclosure may be provided.

The system and method of the present disclosure may be implemented and run on a general-purpose computer or special-purpose computer system. The computer system may be any type of known or will be known systems and may include a hardware processor, memory device, a storage device, input/output devices, internal buses, and/or a communications interface for communicating with other computer systems in conjunction with communication hardware and software, etc.

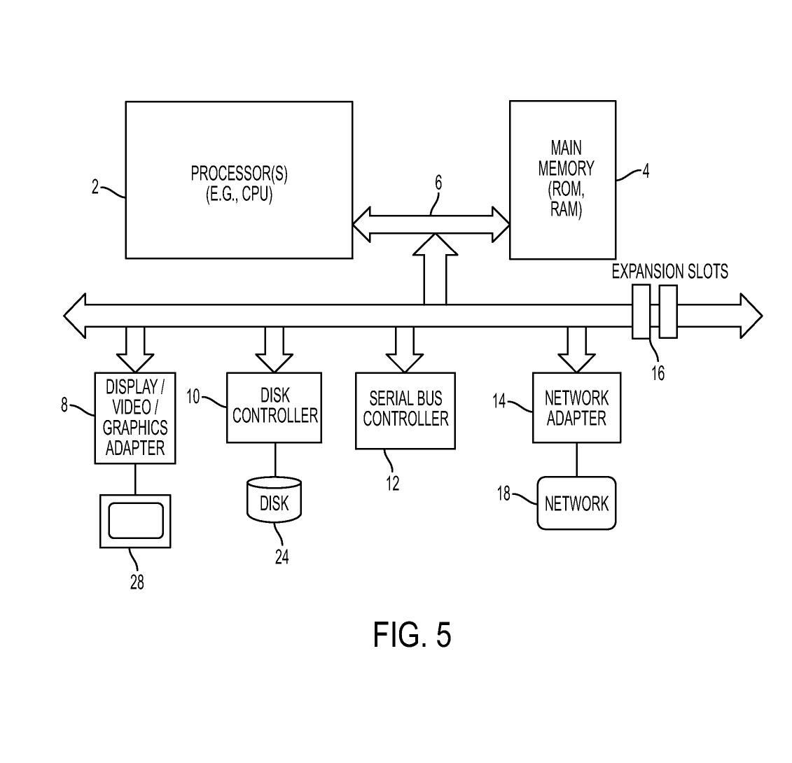

FIG. 5 illustrates an example processing device that may implement the system and/or method of the present disclosure. For instance, a user device or a backend system may include components shown in FIG. 5. One or more central processing units (e.g., CPUs) 2 may include one or more arithmetic/logic unit (ALU), fast cache memory and registers and/or register file. Registers are small storage devices; register file may be a set of multiple registers. Caches are fast storage memory devices, for example, comprising static random access (SRAM) chips. Caches serve as temporary staging area to hold data that the CPU 2 uses. Shown is a simplified hardware configuration. CPU 2 may include other combination circuits and storage devices. One or more central processing units (CPUs) 2 execute instructions stored in memory 4, for example, transferred to registers in the CPU 2. Buses 6, for example, are electrical wires that carry bits of data between the components. Memory 4 may include an array of dynamic random access memory (DRAM) chips, and store program and data that CPU 2 uses in execution. The system components may also include input/output (I/O) controllers and adapters connected to the CPU 2 and memory 4 via a bus, e.g., I/O bus and connect to I/O devices. For example, display/graphic adapter connects 8 a monitor 28 or another display device/terminal; disk controller 10 may connect hard disks 24, for example, for permanent storage; serial controller 12 such as universal serial bus (USB) controller may connect input devices such as keyboard and mouse, output devices such as printers; network adapter 14 connects the system to another network, for example, to other machines. The system may also include expansion slots to accommodate other devices to connect to the system. For example, a hard disk 24 may store the program of instructions and data that implement the above described methods and systems, which may be loaded into the memory 4, then into the CPU's storage (e.g., caches and registers) for execution by the CPU (e.g., ALU and/or other combination circuit or logic). In another aspect, all or some of the program of instructions and data implementing the above described methods and systems may be accessed, and or executed over the network 18 at another computer system or device. FIG. 5 is only one example of a computer system. The computer system that may implement the methodologies or system of the present disclosure is not limited to the configuration shown in FIG. 5. Rather, another computer system may implement the methodologies of the present disclosure, for example, including but not limited to special processors such as field programmable gate array (FPGA) and accelerators.

In one embodiment, the present invention may be embodied as a computer program product that may include a computer readable storage medium (or media) and/or a computer readable storage medium. Such computer readable storage medium may store computer readable program instructions for causing a processor to carry out one or more methodologies described here. In one embodiment, the computer readable storage medium includes a tangible device that can retain and store instructions for use by an instruction execution device. Examples of the computer readable storage medium may include, but is not limited to, an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The terms “computer system” and “computer network” as may be used in the present application may include a variety of combinations of fixed and/or portable computer hardware, software, peripherals, mobile, and storage devices. The computer system may include a plurality of individual components that are networked or otherwise linked to perform collaboratively, or may include one or more stand-alone components. The hardware and software components of the computer system of the present application may include and may be included within fixed and portable devices such as mobile phone, tablet, smartphone, desktop, laptop, and/or server. A module may be a component of a device, software, program, or system that implements some “functionality”, which can be embodied as software, hardware, firmware, electronic circuitry, or etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of providing transportation, comprising:
presenting a user interface to allow a user to enter trip information comprising at least a pickup location and a destination location;
receiving the trip information entered on the user interface;
searching for available vehicles within a threshold distance of the pickup location, positions of the available vehicles determined via a global positioning system;
receiving from the user fare offer information;
transmitting via a communication network, the trip information and the fare offer information to processing devices associated respectively with the available vehicles;
presenting on the user interface at least one of:
vehicle information associated with the available vehicles that have accepted the fare offer information, to allow the user to select a vehicle;
the vehicle information associated with the available vehicles that have presented counter-offers to the user's fare offer information, to allow the user to select a vehicle;
a selection of available vehicles, driver profiles and ratings that have accepted the fare and are available to service the request;
a selected vehicle;
notifying the selected vehicle of the user's selection via the communication network;
receiving from the selected vehicle a confirmation that the selected vehicle is en route to the pickup location; and
presenting the confirmation on the user interface.

2. The method of claim 1, further comprising:
presenting on the user interface payment processing information and payment receipt.

3. The method of claim 1, wherein the user interface displays a geographical map associated with a current location of the user, the current location determined by a global positioning system receiver device coupled to the user device.

4. The method of claim 1, wherein the user interface displays a geographical map associated with a current location of the user and positions of the available vehicles, the current location determined by a global positioning system receiver device coupled to the user device.

5. The method of claim 1, further comprising providing an option on the user interface to allow the user to select a vehicle type, wherein the available vehicles of the vehicle type are located within the threshold distance of the pickup location.

6. The method of claim 1, further comprising presenting a slide bar input element on the user interface that displays a range of fares, from which the user can select for providing the fare offer information.

7. The method of claim 1, wherein the range of fares displayed on the user interface is retrieved from a fare database storing fares according to location zones.

8. A computer readable storage medium storing a program of instructions executable by a machine to perform a method of providing transportation, the method comprising:
presenting a user interface to allow a user to enter trip information comprising at least a pickup location and a destination location;
receiving the trip information entered on the user interface;
searching for available vehicles within a threshold distance of the pickup location, positions of the available vehicles determined via a global positioning system;
receiving from the user fare offer information;
transmitting via a communication network, the trip information and the fare offer information to processing devices associated respectively with the available vehicles;
presenting on the user interface at least one of:
vehicle information associated with the available vehicles that have accepted the fare offer information, to allow the user to select a vehicle;
the vehicle information associated with the available vehicles that have presented counter-offers to the user's fare offer information, to allow the user to select a vehicle;
a selection of available vehicles, driver profiles and ratings that have accepted the fare and are available to service the request;
a selected vehicle;
notifying the selected vehicle of the user's selection via the communication network;
receiving from the selected vehicle a confirmation that the selected vehicle is en route to the pickup location; and
presenting the confirmation on the user interface.

9. The computer readable storage medium of claim 8, further comprising:
presenting on the user interface payment processing information and payment receipt.

10. The computer readable storage medium of claim 8, wherein the user interface displays a geographical map associated with a current location of the user, the current location determined by a global positioning system receiver device coupled to the user device.

11. The computer readable storage medium of claim 8, wherein the user interface displays a geographical map associated with a current location of the user and positions of the available vehicles, the current location determined by a global positioning system receiver device coupled to the user device.

12. The computer readable storage medium of claim 8, further comprising providing an option on the user interface to allow the user to select a vehicle type, wherein the available vehicles of the vehicle type are located within the threshold distance of the pickup location.

13. The computer readable storage medium of claim 8, further comprising presenting a slide bar input element on the user interface that displays a range of fares, from which the user can select for providing the fare offer information.

14. The computer readable storage medium of claim 13, wherein the range of fares displayed on the user interface is retrieved from a fare database storing fares according to location zones.

15. The computer readable storage medium of claim 8, wherein the vehicle information comprises at least driver information, service level, and fare information.

16. A system for providing transportation, comprising:
a processor coupled to a user device,
the processor operable to present a user interface on the user device to allow a user to enter trip information comprising at least pickup location, the user interface displaying a geographical map associated with a current location of the user, the current location determined by a global positioning system receiver device coupled to the user device;
the processor further operable to receive the trip information entered on the user interface;
the processor further operable to cause a server to search for available vehicles within a threshold distance of the pickup location, positions of the available vehicles determined via a global positioning system;
the processor further operable to receive from the user fare offer information;
the processor further operable to transmit via a communication network, the trip information and the fare offer information to processing devices associated respectively with the available vehicles;
the processor further operable to present on the user interface at least one of:
vehicle information associated with the available vehicles that have accepted the fare offer information, to allow the user to select a vehicle;
the vehicle information associated with the available vehicles that have presented counter-offers to the user's fare offer information, to allow the user to select a vehicle;
a selection of available vehicles, driver profiles and ratings that have accepted the fare and are available to service the request;
a selected vehicle;
the processor further operable to notify the selected vehicle of the user's selection via the communication network;
the processor further operable to receive from the selected vehicle a confirmation that the selected vehicle is en route to the pickup location; and
the processor further operable to present the confirmation on the user interface.

17. The system of claim 16, wherein the processor is further operable to present on the user interface payment processing information and payment receipt.

18. The system of claim 16, wherein the user interface further displays the positions of the available vehicles.

19. The system of claim 16, wherein the processor is further operable to provide an option on the user interface to allow the user to select a vehicle type, wherein the available vehicles of the vehicle type are located within the threshold distance of the pickup location.

20. The system of claim 16, wherein the processor is further operable to present a slide bar input element on the user interface that displays a range of fares, from which the user can select for providing the fare offer information, wherein the range of fares displayed on the user interface is retrieved from a fare database storing fares according to location zones.
